(19) United States
(12) Patent Application Publication
(10) Pub. No.: US 2020/0386287 A1
(43) Pub. Date: Dec. 10, 2020

(54) VEHICULAR BRAKE ROTOR WITH NO INTERMEDIATE COATING LAYER

(71) Applicant: Gerald Martino, Mt. Pleasant, PA (US)

(72) Inventor: Gerald Martino, Mt. Pleasant, PA (US)

(21) Appl. No.: 16/435,539

(22) Filed: Jun. 9, 2019

(51) Int. Cl. F16D 65/12; F16D 69/02

(52) U.S. Cl. CPC F16D 65/127; F16D 65/125; F16D 2065/1308; F16D 2200/0021; F16D 2200/003; F16D 69/027

(57) ABSTRACT

A vehicular brake rotor uses chrome carbide to acquire a higher coefficient of friction without need for an intermediate coat layer. After application of an aluminum bond coat layer, there is applied a second (of only two) layers comprised of ceria-stabilized zirconium, said layer comprising a 20-50 wt. % mixture of Ni—Al bond coat and zirconium and a 5-30 wt. % of chrome carbide.

### BACKGROUND OF THE INVENTION

### 1. Field of the Invention

The present invention generally relates to brake rotors for motor vehicles, including brake rotors which are suitable for race cars.

Further, the present invention also generally relates to brake rotors for motorcycles, including racing motorcycles. Other motor vehicles to which the present invention can relate include three-and two-wheeled motorcycles, as well as three-or four-wheeled ATV vehicles.

### 2. Background Information

In automobile and motorcycle racing, as well as in other contexts relating to motor vehicles, there can be several critical factors that may influence the performance of the vehicle in question. One important factor is weight in that an excessively heavy vehicle may not be able to perform effectively. This factor may, for example, have a decisive influence on the speed and fuel economy of the vehicle. Another important factor may be the ability for the vehicle to brake effectively. Particularly, the ability of the vehicle to stop quickly and efficiently, as well as the need to prevent excessive overheating of the brakes, can be tremendously important.

A disadvantage often encountered with such rotors is excessive weight, both in terms of un-sprung weight and rotating weight. Such excessive weight may often result in poor fuel economy, as well as an inhibited capability to accelerate. Typically, such a rotor may weigh between 15 to 30 pounds each. So a set of four brake rotors on a four-wheeled vehicle would result in a total weight of about 60 to 120 pounds. This has long been considered to be excessive for certain contexts, particularly race cars. Using titanium rotors may lower the rotating mass by at least about sixty pounds. Aluminum has its own drawbacks. A1 rotors melt at about 1200° F. . . . and they get “rubbery” at around 800° F. That makes them totally unsafe for most any automotive application, racing or otherwise.

In conventional rotors, braking problems may also result from a coefficient of friction which may not be as high as desired for certain applications, such as in the context of race cars or racing motorcycles. In the case of conventional cast iron rotors, another disadvantage often encountered is the presence of void or stresses in the casting.

It has also been known to coat the braking surfaces of a brake rotor with a ceramic to provide a higher coefficient of friction than would normally be encountered with a plain cast iron or steel rotor. To date, such ceramics have often included a variety of materials. However, problems relating to durability may be experienced in these contexts. Particularly, in many known applications, it has been found that the ceramic coating may have a tendency to develop cracks with increased use, especially if high braking temperatures are created at the surface of the ceramic coating.

U.S. Pat. No. 5,224,572 disclosed a ceramic coating on each of the two braking surfaces of an aluminum rotor. Therein, a plurality of circumferentially spaced cooling apertures was arranged between the braking surfaces. The apertures extended radially, between the large central aperture of the rotor and the outer circumference of the rotor, and essentially act to vent away excessive heat. However, that aluminum-vaned rotor was not necessarily provided with as significant a degree of thermal protection as may often be desired in certain contexts, such as for a racing car or motorcycle. Further, it has been also found that aluminum-vaned rotor did not provide as great a reduction in un-sprung weight or rotating weight.

In the context of motorcycles, especially racing motorcycles, weight reduction can be a particularly important consideration. For a given rotor, it would appear that a reduction in rotor weight would be proportionally more significant in a motorcycle than in an automobile, owing to what would appear to be a significantly proportionally reduced weight of a motorcycle in comparison with an automobile. Thus, it would appear that a motorcycle, such as a racing motorcycle, having rotors with significantly reduced weight in comparison with conventional rotors, could be at a tremendous advantage with regard to performance and fuel efficiency, especially in the context of racing.

This inventor has tried bare rotors made of a titanium composition. However, bare rotors having a titanium composition did not always tend to provide desired advantages of heat resistance or reflection. Further, at high speeds and high brake temperatures, bare titanium rotors, as well as other bare rotors, may “gauld” or “gall”. Such “gaulding” or “galling” can essentially be thought of as undesirable rubbing or chaffing on the rotor surface, with the result of wearing away part of the rotor surface, at least partly possibly accounted for by the swelling of the rotor surface at high temperatures.

Therefore, it appears that a need has arisen for lightweight rotors capable of enhancing the performance and fuel efficiency of motor vehicles, including motorcycles, and which do not possess the disadvantages of carbon-fiber rotors or other rotors such as bare titanium rotors.

It is also desirable to avoid another prior art problem of tungsten carbide gassing at high temperatures.

### Object of the Invention

It is an object of the present invention to provide a brake rotor that overcomes the disadvantages discussed above in relation to known types of prior art, brake rotors. More specifically, the invention seeks to provide optimally functional brake rotors that have the characteristics of reduced weight and increased thermal protection and which can be produced at reasonable cost.

### SUMMARY OF THE INVENTION

The above objects, among others, are achieved by the present invention in the provision of a TWO LAYER coating to titanium, steel and/or stainless brake rotor components, most preferably rotors made from various known (or subsequently developed) titanium alloys. This same two layer coating (i.e., without an intermediate coat) can also be used for all forms of steel or stainless brake components—an a single plane rotor, a vane cast rotor, or a billet vaned rotor.

This invention uses chrome carbide to acquire a higher coefficient of friction. There is no longer a need for an intermediate coat layer. After application of a nickel-aluminum bond coat layer, about 0.002-0.005 in. thick, there is applied a SECOND (of only two) layers (or the “top coat layer”) comprised of ceria-stabilized zirconium oxide, preferably from 0.0010 to 0.0015 in. thick, said layer preferably including a 5-50 wt. % mixture of nickel-aluminum bond coat and ceramics (i.e. zirconium oxide) along with between about 5-30 wt. % chrome carbide depending on the particular brake end use application for which the rotor component is being made.

Additionally, according to at least one preferred embodiment of the present invention, there are preferably a series of apertures, passages or holes drilled between the braking surfaces of the rotor. This characteristic has also been found, surprisingly, to increase ventilation and thereby further contribute to the dissipation of high temperatures at the surface of the brake rotor. Further, it has been found that the ceramic coating according to the present invention is surprisingly durable, even around the apertures, where it might otherwise be expected that significant damage to the coating may occur.

In one embodiment of the present invention, the brake rotor is manufactured from high carbon, stress-relieved steel. This appears to provide the advantages of avoiding the types of voids or stresses that may be present in a cast iron product. Additionally, the use of plate steel appears to allow for less expansion and contraction and appears to allow for a significantly high bond strength and tensile strength. Compared with a conventional rotor, anywhere from about five to about eight pounds of rotating weight may be saved. Further, a rotor manufactured in accordance with at least one preferred embodiment of the present invention can provide a reduction in weight of about twelve ounces, in comparison with a varied, aluminum rotor.

Generally, in view of the features disclosed by the present invention, it is possible to provide a brake rotor that has reduced weight and increased thermal insulation in comparison with known brake rotors. It is essentially possible, by virtue of the present invention, to also provide a brake rotor that has a reduced thickness when compared with other known brake rotors.

In another preferred embodiment, the brake rotor is manufactured from a composition that includes a significant proportion of titanium. Titanium combines a light weight with high temperature strength. This appears to provide significant advantages in weight reduction in comparison with known conventional rotors, including carbon-fiber rotors and even steel rotors. In comparison with steel, it is believed that a weight reduction of between about 50% and 60% can be achieved. In the context of the motorcycle, such as a racing motorcycle, the weight reduction can be decisively significant, in that the performance and fuel efficiency of the motorcycle can be significantly enhanced, to a proportionally higher degree than in the case of four-wheeled motor vehicles. Significant advantages of thermal protection can also be obtained if a ceramic coating such as that described heretofore is utilized in conjunction with the titanium rotor. Particularly, it has been found, surprisingly, that a titanium rotor coated with a ceramic provides significant advantages of heat resistance and reflection in comparison with the known rotors.

As will be apparent from the disclosure that follows, the present invention encompasses both single-plane rotors and vaned rotors. Vaned rotors have parallel planes separated by vanes.

### BRIEF DESCRIPTION OF THE DRAWINGS

The present invention will be more readily appreciated with reference to the accompanying drawings, in which:

FIG. 1 shows a plan view of a brake rotor according to the present invention;

FIG. 2. shows an elevational view of the brake rotor illustrated in FIG. 1;

FIG. 3 is a cross-section, taken along III-III of FIG. 1, which schematically illustrates different layers associated with a brake rotor according to the present invention and

FIG. 4 illustrates a typical brake assembly employing a brake rotor according to the present invention.

### DESCRIPTION OF THE PREFERRED EMBODIMENTS

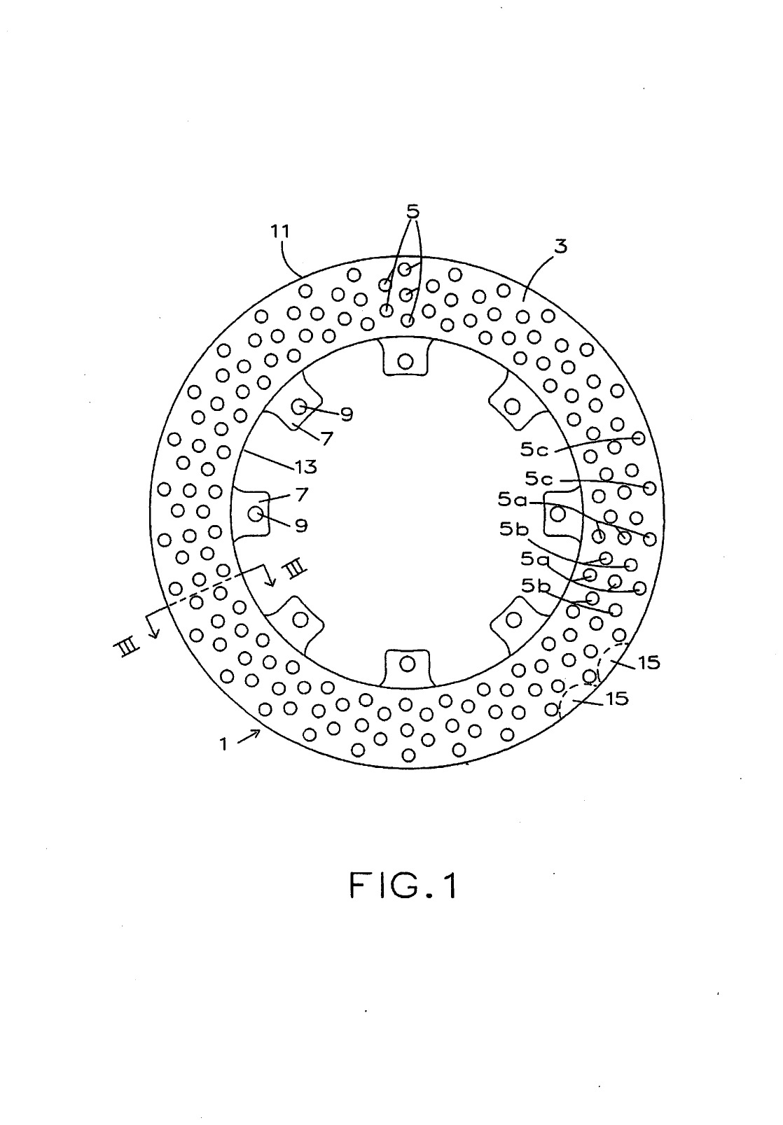

In accordance with one embodiment of the present invention, as illustrated in FIG. 1, brake rotor 1, preferably ring-like in shape, preferably includes two opposite braking surfaces 3, one of which is shown in FIG. 1. The braking surfaces are preferably oriented parallel to one another.

Preferably disposed through brake rotor 1 are a plurality of holes, passages or apertures 5, which preferably extend from one braking surface 3 to the opposite braking surface 3. These holes, passages or apertures 5 preferably extend through the entire thickness of the brake rotor 1, preferably in a direction perpendicular to the braking surfaces 3.

As shown in FIG. 1, in accordance with a preferred embodiment of the present invention, the holes, passages or apertures 5 are preferably distributed about substantially the entire circumferential extent of the brake rotor 1. Preferably, holes, passages or apertures 5 are distributed in a substantially uniform array about the circumferences of brake rotor 1. Preferably, the holes, passages or apertures 5 may be distributed in such a way as to provide considerably reduced weight in comparison with a similar rotor having no holes, while still allowing optimal functionality of the rotor 1. This optimal functionality would include, for example, the ability of the brake rotor 1 to provide sufficient braking via the application of friction pads against the braking surfaces 3.

In the context of race cars or racing motorcycles, it has been found that an array of holes, passages or apertures 5 similar to that illustrated in FIG. 1, can help provide these optimal characteristics. Preferably, with regard to each braking surface, in accordance with at least one embodiment of the present invention, the removed surface area represented by the holes or apertures 5 may represent about 60 percent of the total surface area of the braking surface in question. Within the scope of this invention, said figure could be between about 55 percent and about 65 percent of the total surface area of the braking surface in question. Alternatively, within the scope of the present invention, this figure could be between 45 percent and about 65 percent of the total surface area of the braking surface in question. Additionally, this figure may also be one of the following: 40% or less, 70% or 75% or more, or any value intermediate to an of the values mentioned heretofore.

The rotor 1 preferably has an outer peripheral surface 11 and an inner peripheral surface 13, both of which surfaces 11, 13 preferably connect both braking surfaces 3 with each other.

A plurality of lugs 7, preferably eight in number, are preferably arranged uniformly about the inner peripheral surface 13 of the rotor 1 and extend radially inwardly. Each lug 7 is preferably appropriately provided with a hole 9 for connection with a hub member.

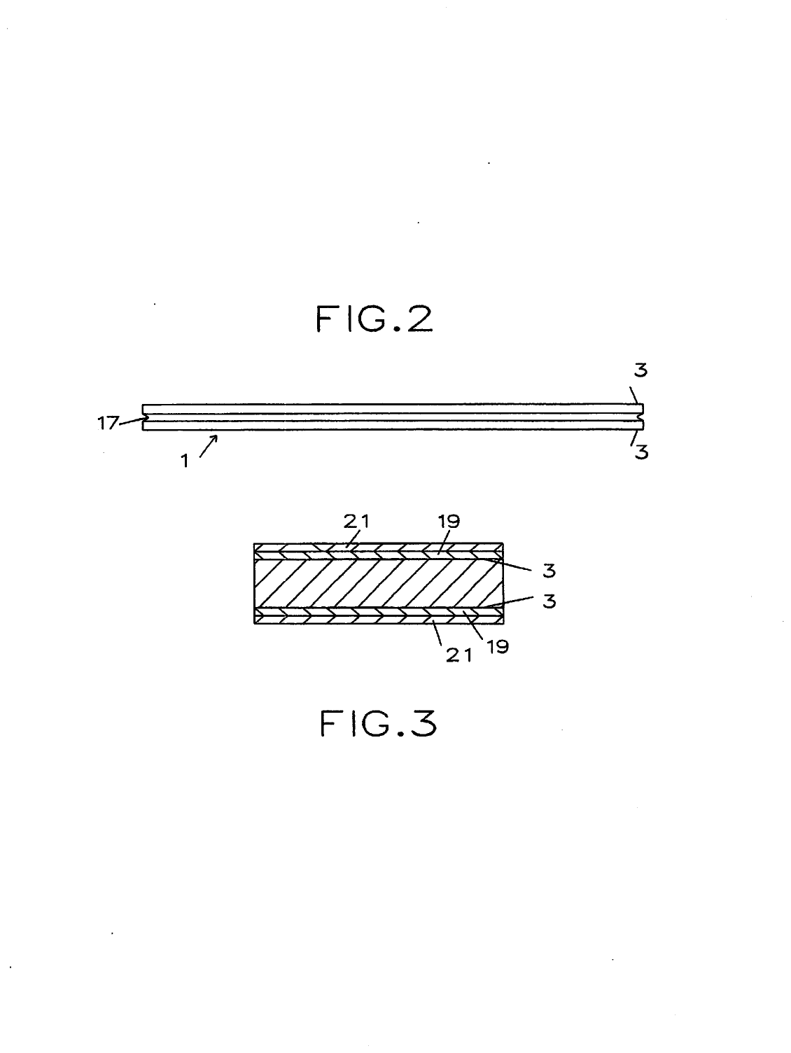

FIG. 2 is an elevational view of the brake rotor illustrated in FIG. 1. Preferably, the outer peripheral surface 11 (see FIG. 1) of the rotor 1 is indented about substantially its entire circumference with a groove 17.

The disclosure now briefly turns to an illustrative example of brake rotor with physical dimensions. Reference can be made to both FIG. 1 and FIG. 2.

As an illustrative example, rotor 1 may have an outer diameter, at outer peripheral surface 11, of about 11.75″ and an inner diameter, at inner peripheral surface 13, of about 8.75″. Accordingly, the radial dimension of the ring constituted by the rotor 1, as measured between outer peripheral surface 11 and inner peripheral surface 13, may be about 1.5″.

There may he sixty sets of apertures 5 distributed about the rotor 1, each set of apertures having two or three apertures, wherein all of the apertures within each set may be aligned along a common radius of the rotor 1. There may be two alternating patterns 5a, 5b of apertures among the sixty sets of apertures as follows:
thirty sets 5a of the apertures may be constituted by three apertures each, wherein the two apertures closer to the center of the rotor may have a diameter of about ⅜″ and the aperture furthest away from the center of the rotor, indicated at 5c, may have a diameter of about 5/16″, and wherein the apertures may be substantially evenly spaced; and
thirty sets 5b of the apertures may be constituted by two apertures each, wherein each aperture has a diameter of about ⅜″.

In accordance with at least one embodiment of the present invention, between outer apertures 5c of respective sets 5a, generally along the outer circumference of rotor 1, there may preferably be what may be considered bights of material 15, indicated schematically by dotted lines in FIG. 1, projecting into the general pattern of apertures 5. In other words, the positioning of outer apertures Sc relative to the sets of apertures Sb may preferably be such that a noticeable amount of plate material exists between the radially outermost aperture of each set 5b and the outer peripheral surface 11. As an example, the distance between the radically outermost point on the radially outermost aperture 5 of a set of apertures 5b and the outer peripheral surface 11 of rotor 1 may be about 11/32″, whereas the distance between the radially outermost point of an aperture 5c and the outer peripheral surface 11 of rotor 1 may be about ⅛″. Thus, a bight, or encroachment, of material 15, towards the center of the rotor 1, may be seen repeatedly about the outer circumference of the rotor 1. Conceivably, the presence of these bights 15 may, in the presence of apertures 5, aid in braking, by creating a somewhat expanded locus of contact between a friction pad and braking surface 3.

The brake rotor 1 may have an overall thickness of about ¼″. The axial dimension of the circumferential groove 17, defined parallel to the thickness of the rotor 1 and perpendicular to the braking surfaces 3, may be about 3/32″.

Each lug 7 may have a radial dimension, defined along a radius of rotor 1, of about ¾″, and may have a transverse dimension, defined generally transverse to the radial dimension, of about 15/16″. Each hole 9 may have a diameter of about 11/32.

Each hole 5 is preferably beveled at each braking surface 3. Additionally, each hole 9 is preferably beveled at each opposing surface of the corresponding lug 7.

It has been found that a steel rotor having dimensions and characteristics as set forth hereinabove may have a weight of about 3 lbs., 9 or 10 ounces; that is, 57 or 58 ounces.

It will be understood that the foregoing merely represents an example for the purposes of illustration, and that brake rotors having different dimensions, and different arrangements of apertures, are conceivable within the scope of the present invention. For example, it is conceivable to provide apertures not in the form of circular holes, but in the form of circumferentially oriented slits or perforations.

It will also be understood that, in accordance with at least one preferred embodiment of the present invention, the dimensions set forth heretofore may conceivably vary by a factor of about plus or minus one-third of the cited dimension, especially in the case of smaller dimensions. Other dimensions and proportions, relating to the illustrative example set forth heretofore, may be divined from FIG. 1, as FIG. 1 may be considered to be essentially drawn to scale with relation to the illustrative example set forth heretofore.

FIG. 3 provides a detailed, and essentially highly exaggerated, view of a cross-section of rotor 1, the cross-section being taken along line III-III of FIG. 1. As illustrated schematically in FIG. 3, each braking surface 3 preferably has disposed thereupon a bonding layer 19 and a thermal barrier layer 21. The particular composition of these layers will be discussed more fully below, as well as methods for applying the same to the braking surfaces 3. Generally, however, bonding layer 19 may preferably include a thin layer of nickel-aluminum, preferably about 95:5 wt. % Ni to Al. The thermal barrier layer 21, on the other hand may include, in accordance with at least one preferred embodiment, a mixture of Ni—Al bond coat with a ceria-stabilized zirconium oxide.

Preferably, bonding layer 19 and thermal barrier layer 21 will each be applied to the braking surfaces 3 by plasma spraying techniques well known to those of ordinary skill in the art.

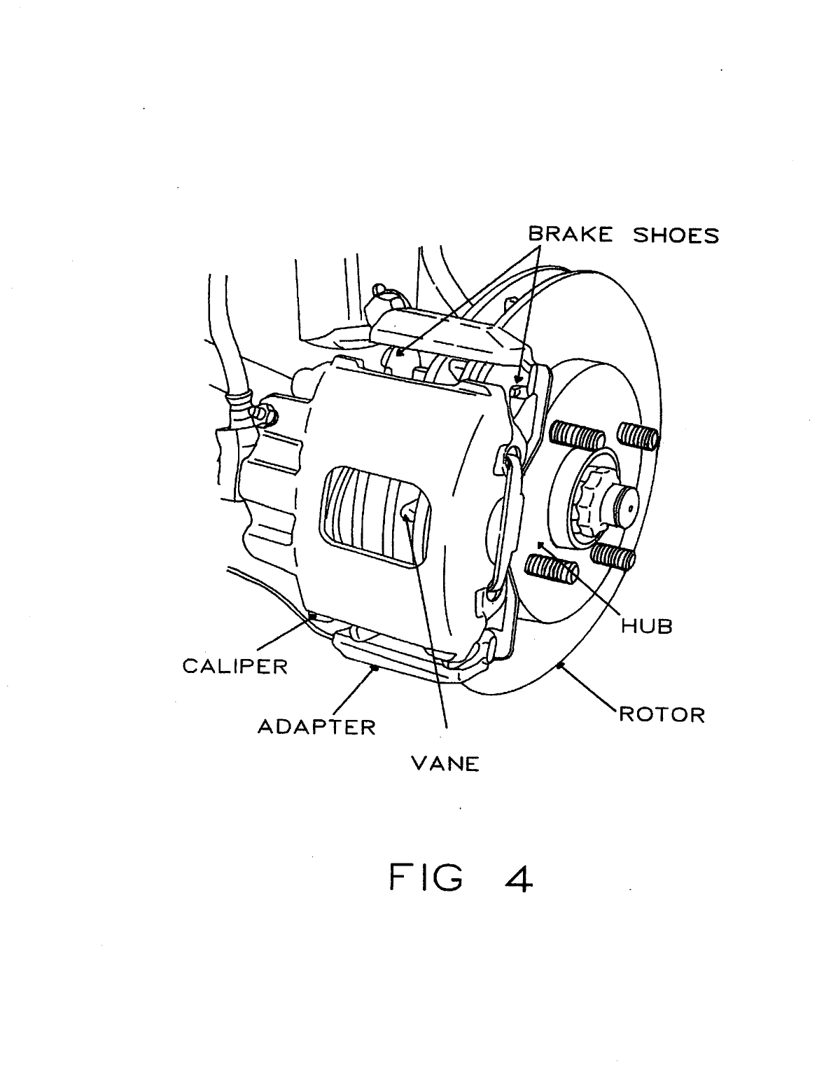

FIG. 4 illustrates a typical brake assembly in which a brake rotor according to the present invention may be employed. Various components of the brake assembly are indicated by name. It will be understood that the “brake shoes” may essentially be considered as including friction pads. Unlike the single-plane rotor of FIGS. 1 to 3, the rotor of FIG, 4 is a vaned rotor composed of two planes, made, for instance, of titanium or titanium alloy and each having an outwardly facing braking surface provided with a ceramic coating. The two planes are separated by inwardly situated vanes. The rotors of the invention may, or may not, have holes 5 in the braking surfaces, and, to illustrate this variation, the vaned rotor illustrated in FIG. 4 does not have holes 5. Vaned rotors may be manufactured using jigs to hold the vanes in place relative to the planes, followed by TIG welding of the vanes to the interior surfaces of the planes. Alternatively, vaned rotors may cast as one unit, using casting processes, such as investment casting.

In comparative tests, braking pressure was used to bring rotor temperature to 1000° F., as measured with a probe-equipped pyrometer. It is found that hub temperature is 50 to 100° F. cooler for a titanium rotor of the invention, as compared to a steel rotor. Thus, temperature of an aluminum hub will be around 250° F. for the steel rotor, as compared with about 150 to 175° F. for the titanium rotor. It is believed that this is an effect of the lower thermal conductivity of the titanium rotor, as compared to steel, so that the temperature increase in the ceramic coating is not conducted as easily to the hub.

The disclosure now turns to a discussion of a preferred method for forming a brake rotor in accordance with the present invention, For this purpose, reference may be made to FIGS. 1-3.

Fundamentally, brake rotor 1 may preferably be formed from a high-carbon stress relieved steel. The rotor may then be provided with apertures 5, preferably in an array characterized in a similar vein as the array described heretofore with relation to the illustrative example. Additionally, the rotor 1 may preferably be provided with the aforementioned circumferential groove 17 by an appropriate method. Such a method for providing a circumferential groove is generally well known to those of ordinary skill in the art and will not be described in further detail here.

In accordance with another preferred embodiment of the present invention, brake rotor 1 may preferably be formed from a composition that includes a significant proportion of titanium. As with a steel rotor, the rotor may then be provided with apertures 5, preferably in an array characterized in a similar vein as the array described heretofore with relation to the illustrative example. Additionally, the rotor may preferably be provided with the aforementioned circumferential groove 17 by an appropriate method. Such a method for providing a circumferential groove is generally well known to those of ordinary skill in the art and will not be described in further detail here.

Preferably, then, a titanium-based rotor according to the present invention will have a highly significant percentage of titanium therein, such as about 86% or 87% or more. In at least one preferred embodiment of the present invention, this proportion could be considered as being about 85 percent or more. Conceivably, then, it is possible, within the scope of the present invention, to provide a titanium rotor having very significantly high percentages of titanium, such as about 86 percent, about 88 percent, about 90 percent, about 92 percent, about 94 percent, about 96 percent, about 98 percent, and even 99 percent or more. It is conceivable, within the scope of the present invention, to form the brake rotor 1 out of pure titanium, that is 100 percent titanium. Appropriately, the presence of titanium in the composition may be at a proportional value intermediate to those listed immediately here and above.

Titanium which is essentially unalloyed has nevertheless the strength to serve as a material of construction for brake rotors. An example of essentially unalloyed titanium is specified under ASTM B-265-94 and ASML SB-265 A90 Grade 2, material annealed by heating to 1400° F. with subsequent air cool.

If material of this same composition is TIG welded as vanes between two annular planes of it cut from plate material, in order to form a vaned rotor, the finished product is given a normalizing, stress-relief heat treatment of 1200° F. for one hour followed by air cool, before grit-blasting preparatory to the ceramic coating process.

Alternatively, it is conceivable, within the scope of the present invention, that amounts of titanium lower than about 80 percent could be utilized. For example, it is conceivable to utilize about 78 percent, about 76 percent, about 74 percent, about 72 percent, and about 70 percent titanium within the scope of the present invention, or any values intermediate to these values.

Unless otherwise noted, the remainder of the present disclosure is equally applicable to steel rotors and rotors formed from a titanium composition/alloy, as well as rotors formed from other metals.

Preferably, the rotor 1 is grit- or sand-blasted in preparation for receipt of the aforementioned coatings 19, 21 on the respective braking surfaces 3. Suitable sand-blasting techniques are generally well-known to those of ordinary skill in the art and will not be described in further detail herein. Subsequent to sand-blasting, the braking surfaces 3 of the rotor are preferably bond-coated, most preferably by plasma-spraying, with nickel-aluminum to a thickness of about 0.005 inches. The temperature maintained during the plasma spraying process may preferably be between about 10,000° F. and about 12,000° F.

Although the preferred thickness of the bond coating has been cited hereinabove as 0.005 inches, and has been found to produce essentially optimal results, it will be appreciated that satisfactory results can also be achieved with thicknesses slightly higher or lower than 0.005 inches. Particularly, it is conceivable, within the scope of the present invention, to provide thicknesses of about 0.003 inches, about 0.0035 inches, about 0.004 inches, about 0.0045 inches, about 0.0055 inches, about 0.006 inches, about 0.0065 inches or about 0.007 inches. Values lower than 0.003 inches or higher than 0.007 inches may also produce satisfactory results.

The outer ceramic coating 21 is preferably also provided by a plasma-spraying technique, preferably to a thickness of between about 0.01 inches and about 0.03 inches, and more preferably in the range 0.005 to 0.015 inches. Preferably, the top coat comprises an outer ceramic coating of ceria-stabilized zirconium oxide mixed with 5 to 50% nickel-aluminum. This grading of bond coat into the single coating layer (with no intermediate coating) decreases the abruptness of changes in coefficient of thermal expansion from one layer to the next.

Additionally, it will be understood that, in accordance with at least one preferred embodiment of the present invention, the thickness of the ceramic coating may preferably be about 0.01 inches, about 0.015 inches, about 0.02 inches, about 0.025 inches or about 0.03 inches. Values outside the range of about 0.01 inches to about 0.03 inches may also produce satisfactory results, such as: about 0.005 inches, about 0.006 inches, about 0.007 inches, about 0.008 inches, about 0.009 inches, about 0.031 inches, about 0.032 inches, about 0.033 inches, about 0.034 inches and about 0.035 inches.

It has been found that, generally, a ceramic coating as described hereinabove can essentially reflect heat in such a way that the coating retains its original color, that is the color of the coating prior to braking, at temperatures of up to about 1200° F.

Coatings composed of more than two layers may, of course, be used, for instance for the purpose of making transitions between different coefficients of thermal expansion less abrupt, or for the purpose of introducing various kinds of materials offering special advantages.

Preferably, in accordance with at least one preferred embodiment of the present invention, each of the lugs 7 is uncoated, that is, does not have disposed thereupon, either bonding layer 19 or ceramic coating 21.

Preferably, in accordance with at least one preferred embodiment of the present invention, the interior surfaces of the holes 5 will have both the bond coating and ceramic coating disposed thereupon, for thermal protection.

In at least one preferred embodiment of the present invention, there may preferably be, in the vehicle in which the rotor is mounted, one or more air ducts leading to the vicinity of the rotor in question. Such air ducts, which may conceivably include one or more conduits for introducing fresh air generally from the front of the vehicle to the vicinity of the rotor in question, are generally known to those of ordinary skill in the art and, as such, will not be described in more detail herein.

Whereas the description of air ducts set forth immediately hereinabove can be considered as being applicable to four-wheeled motor vehicles, such as automobiles, it should be understood that similar provisions could be made for motorcycles. Ventilation arrangements for motorcycles, which may conceivably be arranged so as to introduce fresh air to the vicinity of the rotor in question, are generally well known to those of ordinary skill in the art and, as such, will not be described in more detail herein.

To recapitulate, in accordance with at least one preferred embodiment of the present invention, a brake rotor according to the present invention may preferably encompass the following characteristics:
the rotor can preferably be made of a high carbon stress relieved steel or titanium;
the rotor may preferably have essentially any diameter from about seven inches to about fifteen inches;
the rotor is preferably made so as to have a thickness of between about 0.100″ and 0.750″, and is preferably drilled with variously sized holes to lighten the rotor;
the holes are preferably drilled perpendicularly with respect to the rotor, so as to essentially resemble “Swiss cheese”;
the rotor is preferably sand blasted and bond-coated with a high temperature nickel-aluminum plasma spray, to a thickness of about 0.005 in.;
on top of the bond coat, a ceria-stabilized, zirconium oxide plasma spray, preferably having characteristics as described heretofore, is preferably sprayed on the rotor to a thickness of preferably between about 0.010 in. and 0.030 in. as a thermal barrier;

Additionally, in accordance with at least one preferred embodiment of the present invention, it will be appreciated that a brake rotor according to the present invention can essentially exhibit the following advantages:
plate steel, if utilized, allows for less expansion and contraction and allows for very high bond strength, as well as very high tensile strength;
compositions having a significant proportion of titanium, if utilized, appear to provide advantages of significant weight reduction and significantly improved heat reflection or radiation;
the thermal characteristics of the ceramics essentially allows the rotors to be drilled and ground thinner, allowing the use of a much lighter rotor in comparison to a vaned rotor or a conventional single-plane rotor, including an aluminum rotor;
compared to a conventional rotor, a steel rotor can save anywhere from about five to about eight pounds of rotating weight;
a rotor, according to at least one preferred embodiment of the present invention, can out-stop a conventional rotor because of the ceramics having a higher coefficient of friction than a plain cast iron or steel rotor;

a rotor, according to at least one preferred embodiment of the present invention, having steel as described heretofore, can weigh about twelve ounces less than a vaned aluminum rotor of comparable size;
a steel rotor, according to at least one preferred embodiment of the present invention, can be considerably stronger than a conventional cast-iron rotor because of being made of rolled plate, not a cast product, wherein a cast product could have voids or stresses built into the casting;
a rotor, according to at least one preferred embodiment of the present invention, could have many uses, including the provision of an average automobile or motorcycle with less rotating weight, which could, in turn, result in better acceleration and fuel economy; and
a rotor, according to at least one preferred embodiment of the present invention, could be suited for a very wide variety of racing vehicles or other types of performance vehicles, from “go-karts”, to “Indy” cars, to drag racers, to “monster trucks”, and conceivably could be suited for “funny cars”.

Thus, although a brake rotor according to the present invention may essentially be considered to be suitable for NASCAR race cars, it may be suitable for several other types of racing or performance vehicles, as well.

Further, a rotor, according to at least one preferred embodiment of the present invention, could be suited for a very wide variety of racing motorcycles or other types of performance motorcycles, including two-wheeled racing motorcycles, three- or four-wheeled ATV vehicles, and other types of motorcycles.

The appended drawings in their entirety, including all dimensions, proportions and/or shapes in at least one embodiment of the invention, are accurate and to scale and are hereby included by reference into this specification.

All, or substantially all, of the components and methods of the various embodiments may be used with at least one embodiment or all of the embodiments, if any, described herein.

The invention as described hereinabove in the context of the preferred embodiments is not to be taken as limited to all of the provided details thereof, since modifications and variations thereof may be made without departing from the spirit and scope of the invention,

What is claimed is:

1. A vehicle brake rotor having a bond coat of nickel-aluminum and a top coat of nickel-aluminum mixed with ceria-stabilized zirconium oxide and chrome carbide.

2. The brake rotor of claim 1, which is made from titanium or a titanium based alloy.

3. The brake rotor of claim 1, which is made from a steel alloy.

4. The brake rotor of claim 4, which is made from stainless steel.

5. The brake rotor of claim 1, which is a single plane rotor.

6. The brake rotor of claim 1, which is a vaned cast rotor.

7. The brake rotor of claim 1, which is a billet vaned rotor.

8. The brake rotor of claim 1, which has no intermediate coating layer applied thereto.

9. The brake rotor of claim 1 wherein the nickel-aluminum bond coat is about 0.002 to 0.005 in. thick.

10. The brake rotor of claim 9 wherein the bond coat contains about 95 wt. % nickel and 5 wt. % aluminum.

11. The brake rotor of claim 1 wherein the top coat is about 0.01 to 0.015 in. thick.

12. The brake rotor of claim 1 wherein the top coat contains a mixture with about 20-50 wt. % nickel-aluminum bond coat and ceria-stabilized zirconium oxide.

13. The brake rotor of claim 12 wherein the top coat further contains about 5-30 wt. % chrome carbide.

14. A titanium or titanium alloy vehicular brake rotor having a bond coat of nickel-aluminum and a top coat of nickel-aluminum mixed with ceria-stabilized zirconium oxide and chrome carbide but no intermediate coat layer.

15. The titanium or titanium alloy brake rotor of claim 14 wherein the nickel-aluminum bond coat is about 0.002 to 0.005 in. thick.

16. The titanium or titanium alloy brake rotor of claim 15 wherein the bond coat contains about 95 wt. % nickel and 5 wt. % aluminum.

17. The titanium or titanium alloy brake rotor of claim 14 wherein the top coat is about 0.01 to 0.015 in. thick.

18. The titanium or titanium alloy brake rotor of claim 14 wherein the top coat contains a mixture with about 20-50 wt. % nickel-aluminum bond coat and ceria-stabilized zirconium oxide.

19. The titanium or titanium alloy brake rotor of claim 18 wherein the top coat further contains about 5-30 wt. % chrome carbide.
